(19) United States
(12) Patent Application Publication
(10) Pub. No.: US 2022/0072786 A1
(43) Pub. Date: Mar. 10, 2022

(54) HEATING DEVICE WITH INFRARED RADIATING ELEMENTS

(71) Applicant: Heraeus Noblelight GmbH, Hanau (DE)

(72) Inventors: Oliver WEISS, Hanau (DE); Holger ZISSING, Hanau (DE); Johannes LOHN, Paderborn (DE); Peter KOPPA, Verl (DE)

(21) Appl. No.: 17/276,366

(22) PCT Filed: Oct. 9, 2019
(86) PCT No.: PCT/EP2019/077337

§ 371 Date: Mar. 15, 2021

(30) Foreign Application Priority Data
Oct. 12, 2018 (DE) 10 2018 125 310.9

(51) Int. Cl. B29C 64/295; B22F 10/20

(52) U.S. Cl. CPC B29C 64/295; B33Y 30/00; B22F 10/20

(57) ABSTRACT

A heating device for heating a powder during the production of a 3D shaped part. The heating device has an infrared (IR) lamp and a housing in which a construction chamber is provided. The construction chamber is bounded at the bottom by a construction platform for receiving the shaped part and is supported on a support plate. The IR lamp heats the powder during production of the 3D shaped part in the construction chamber. For ensuring an optimized heat transfer to the sintering or melting powder with a particularly homogeneous temperature distribution, a partition wall composed of an IR radiation transparent material is arranged between the construction chamber and the IR lamp.

### CROSS REFERENCE TO RELATED APPLICATIONS

This application is a U.S. National Phase filing of International Patent Application No. PCT/EP2019/077337 filed on Oct. 9, 2019, which claims the priority of German Patent Application No. 102018125310.9 filed on Oct. 12, 2018. The disclosures of these applications are hereby incorporated by reference in their entirety.

### TECHNICAL FIELD

The present invention relates to a heating device for heating a powder during the production of a three-dimensional (3D) shaped part, having an IR lamp and having a housing in which a construction chamber is provided which is bounded at the bottom by a construction platform for receiving the shaped part. The construction platform is supported on a support plate.

Furthermore, the invention relates to a method of producing a 3D shaped part using the heating device.

3D shaped parts are generally produced by layering technology and solidification of a loose powder using selective laser sintering or laser melting. The abbreviations SLS (selective laser sintering) for plastic powders and SLM (selective laser melting) for metal powders are also used. When the powder is heated, whether it is a plastic powder or a metal powder, a homogeneous temperature distribution is necessary to avoid thermal stresses (cracks, distortion) in the finished shaped part.

Infrared lamps (IR lamps for short) within the meaning of the invention are irradiation units with, as a rule, a plurality of lamp tubes, especially fluorescent tubes, composed of fused silica, in which a heating filament (also called a glow wire) is arranged. The heating filament determines the radiation spectrum of the IR lamp.

IR-A radiation has wavelengths in the range of 0.78 μm to 1.4 μm; the wavelengths of IR-B radiation range from 1.4 μm to 3.0 μm; and the wavelengths of IR-C radiation range from 3 μm to 1,000 μm.

### BACKGROUND ART

From DE 10 2015 006 533 A1, the production of a 3D shaped part from a plastic sintering powder is known. For heating the construction platform, a flat, silicone-based heating foil with electrical resistance heating is employed; however, it is barely possible to reach temperatures higher than 200° C. with such a heating foil. This heating temperature is sufficient for heating plastic sintering powders in the production of 3D shaped parts, but not in the production of metallic 3D shaped parts, for which significantly higher process temperatures are needed overall. In addition, lamps mounted laterally to the construction platform are preferred.

Instead of the silicone-based heating foil, it is proposed as an alternative in DE 10 2015 006 533 A1 to control the temperature of the construction platform or the sintering powder located on the construction platform using heating coils through which heat transfer oil flows, and which are arranged below the assembly plate and laterally on the construction platform. The temperature that can be reached with the heating coils is not significantly higher than 200° C., and heat transfer to the sintering powder by this design is inefficient (slow). Moreover, a storage tank and possibly a pump have to be provided for the heat transfer oil in order to convey the heat transfer oil through the heating coils. Overall, these additional devices result in a heating device that is costly without being able to achieve an increase in efficiency in the sense of rapid heat transfer or an extended temperature range.

From DE 10 2012 012 344 B3, a method and a device for producing workpieces by beam melting powdered material are known. To reduce the process-related temperature gradient, the powdered build material is preheated by heating elements instead of with a platform heating system, the heating elements being arranged on or in the side walls of the storage chamber and/or the process chamber.

From DE 10 2015 211 538 A1, a construction cylinder arrangement for a machine for producing 3D objects in layers by laser sintering or laser melting powdered material is known, in which a layer of the powdered material is heated using a heating device with IR heating coils.

### Technical Problem

The present invention is based on the object of providing a heating device having an IR lamp for heating a powder in the production of a 3D shaped part in a construction chamber, which ensures an optimized heat transfer to the sintering or melting powder with a particularly homogeneous temperature distribution. The heating device should additionally act as a high-temperature heating device and should allow simple retrofitting in an existing construction chamber so that use of the heating device is possible in appropriate methods of producing a 3D shaped part.

### SUMMARY OF THE INVENTION

These and other objects are achieved according to the invention in that a partition wall composed of an IR radiation transparent material is arranged between the construction chamber and the IR lamp.

The construction chamber is separated from the IR lamp by a partition wall composed of an IR radiation transparent material.

At least one IR lamp is mounted externally on the partition wall and emits IR radiation towards the powder or the 3D shaped part on the construction platform in the construction chamber. The construction platform lies directly on the height-adjustable support plate or is connected indirectly to the support plate by an assembly plate.

The heating device optionally comprises a partition wall that surrounds the construction chamber laterally as an IR radiation transparent jacket (side wall).

In the production of a 3D shaped part by the SLM method, a laser scans the powder that has been deposited on the construction platform and melts it locally layer by layer. In particular, with metallic materials having high melting points, high temperature gradients can be obtained between the melting regions and the surrounding powder. During an uneven heating and cooling of the work piece, stress cracks can often be formed during the build process of the shaped part.

With the heating device according to the invention, when the powder is heated before and during the laser treatment for the local melting or before a new powder layer is deposited, temperature differences between the shaped part that has already partially solidified and a new layer of powder are levelled out or completely avoided. The powder and the 3D shaped part are instead heated particularly evenly and without a temperature gradient, so that there is no need for any thermal post-treatment of the shaped part to dissipate thermal stresses once it is finished. This means that the production process is quicker and more economical.

A further advantage of the heating device is that the partition wall can be readily replaced in the event of a repair and it is also possible for an existing construction chamber to be retrofitted with the heating device according to the invention.

As a rule, a plurality of IR lamps are arranged on the partition wall of the construction chamber, in which case the IR lamps are preferably part of a lamp arrangement comprising the plurality of IR lamps and the IR lamps of the lamp arrangement are individually electrically controllable. The fact that a plurality of IR lamps can be provided means that individual lamps can be switched on or off to maintain the desired radiation spectrum and, at the same time, to maintain the predefined total irradiation rate. By “predefined” is meant defined or determined beforehand, so that the predefined characteristic (in this case, the total irradiation rate) must be determined, i.e., chosen or at least known, in advance of some event (in this case, before the heating process begins).

It has proved expedient if at least one infrared lamp has an emission spectrum in the IR-A range matched to the absorption characteristics of the powder, i.e., is an IR-A lamp. The preferred short-wave emission spectrum in the IR-A range has peak wavelengths of 9 μm to 13 μm. IR radiation in the IR-A range has a higher radiation energy compared to IR-B radiation. In principle, the greater the radiation energy, the shorter can be the irradiation process that is selected. The IR-A radiation content therefore contributes to an efficient method using the heating device.

It has proved advantageous if the IR radiation transparent partition wall consists of fused silica or a glass ceramic. Fused silica has high transparency to IR radiation and is electrically insulating even at relatively high temperatures; possesses good corrosion resistance, heat resistance, and thermal shock resistance; and is available in high purity. It is therefore suitable for use in particular in high-temperature heating processes. As well as fused silica, glass ceramic can also be employed as an IR radiation transmissive material for forming the side wall.

It has proved particularly expedient if the construction chamber is surrounded in the radial direction by a preferably cylindrical-sleeve-shaped side wall, which is formed at least in part, and preferably entirely, as a partition wall. The partition wall in this case can be formed as a side wall extending peripherally around the construction chamber. The partition wall can have the shape of a hollow cylinder based on a circular or rectangular surface and can be matched to the geometry of the surface of the construction platform. In this way, heat transfer to the powder bed or the shaped part is optimized.

An advantageous embodiment of the heating device provides the IR lamps with at least one reflector on their side facing away from the shaped part. The reflector causes the infrared radiation to be directed onto the powder and/or the 3D shaped part on the construction platform and thus increases the efficiency of the heating device.

The reflector can be formed as a primary reflector, in which case the IR lamp has a cladding tube, which is covered on its side facing away from the shaped part with a primary reflector in the form of a reflector layer deposited on the cladding tube. Preferably, a reflective inside of a housing wall of the housing facing the shaped part additionally forms a secondary or possibly also a tertiary reflector.

To limit heat generation in the region of the housing, the housing wall can be equipped with cooling and/or insulating element. The cooling and/or insulating element insulates the IR lamp from the external environment and can be present as a thermal insulation layer and/or a cooling plate.

In a preferred variant of the heating device, the IR lamp and the side wall are arranged in a frame of a heating unit, which heating unit can be inserted into the housing. The frame has a frame outer wall with a reflective inside facing the shaped part, which forms a secondary reflector. The frame advantageously surrounds a closed inner space, in which the IR lamp is arranged. These embodiments of the heating device are particularly advantageous in connection with a retrofitting solution for existing equipment for producing 3D shaped parts.

The construction chamber preferably has at least one measuring cell for detecting the temperature of the powder and/or of the shaped part. The temperature in the construction chamber can be measured continuously. For this purpose, pyrometers, thermal imaging cameras, or temperature sensors, such as for example thermocouples or resistance sensors, can be employed to measure the temperature.

In a further advantageous embodiment of the heating device, the partition wall has a double-walled configuration forming at least one intermediate space, with the at least one IR lamp being arranged in the intermediate space.

The IR lamp in the intermediate space of the double-walled side wall or partition wall comprises at least one heating filament having an emission spectrum in the IR-B range. Individual heating filaments in this case can be mechanically and electrically separated from each other by webs in the double-walled side wall of the construction chamber.

IR radiation in the IR-B range has lower radiation energy compared to IR-A radiation. With an appropriate duration of the irradiation process and in many cases high absorption of IR-B radiation by the powder or by the shaped part, good irradiation results can also be achieved with IR-B radiation. In addition, the separation of individual heating filaments by webs in the double-walled side wall or partition wall allows targeted control, such that individual heating filaments can be switched on or off concurrently to maintain the desired total irradiation rate in the appropriate radiation spectrum.

The heating device is preferably used in a method of producing 3D shaped parts. Using the method, a 3D shaped part is produced by sintering a preferably at least partially metallic powder in a construction chamber using a laser, wherein the powder and/or the 3D shaped part is or are heated with at least one IR lamp during sintering, and wherein a partition wall composed of an IR radiation transparent material is arranged between the construction chamber and the IR lamp.

It is to be understood that both the foregoing general description and the following detailed description are exemplary, but are not restrictive, of the disclosure.

### BRIEF DESCRIPTION OF THE DRAWING

The invention is explained in more detail below with the aid of a patent drawing and exemplary embodiments. The individual figures of the drawing are schematic diagrams in which:

FIG. 1 is an embodiment of the heating device according to the invention in a side view; and

FIG. 2 is a further embodiment of the heating device with a partial view of the construction chamber.

### DETAILED DESCRIPTION

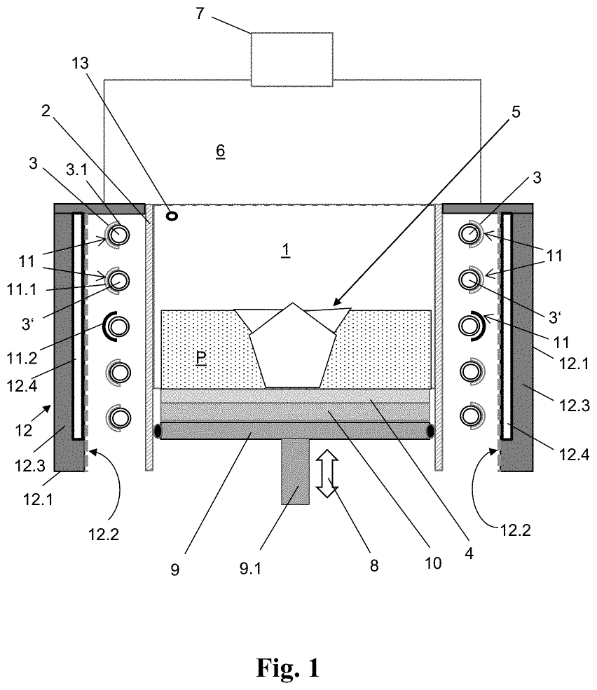

FIG. 1 is a schematic diagram of an embodiment of the heating device. The construction chamber 1 has a peripheral, cylindrical side wall or partition wall 2 composed of fused silica. A plurality of IR lamps 3, 3′ are mounted on the outside of the partition wall 2 and emit IR radiation towards the powder P or the 3D shaped part 5 on the construction platform 4 in the construction chamber 1. For detecting the temperature of the powder P and of the shaped part 5, the construction chamber 1 has a measuring cell 13 in the form of a thermal imaging camera. Above the construction chamber 1, the process chamber 6 is located, in which units (not shown here) for controlling the build process of the shaped parts 5 are accommodated. At the upper end of the process chamber 6, a laser unit 7 is arranged, shown schematically, which is capable of selectively sintering and/or melting the powder P with a high-energy laser beam issuing therefrom for producing the 3D shaped part 5.

The powder P is typically a metal powder, but plastic powders can also be employed. The powder P is located on the construction platform 4, which is arranged on a support plate 9, which is made height-adjustable by a piston 9.1, as indicated by the double direction arrow 8. The construction platform 4 is mounted on an assembly plate 10 which facilitates the replacement of the construction platform 4.

The IR lamps 3, 3′ emit radiation in the IR-A range and are provided with a reflector 11 on their side facing away from the shaped part 5. The reflector 11 causes the IR radiation to be directed onto the powder P and/or the 3D shaped part 5 on the construction platform 4. The reflector 11 is formed as a so-called primary reflector in the form of a reflector layer 11.1 deposited on the cladding tube 3.1 of the IR lamp 3, 3′. The reflector layer 11.1 is, for example, a gold layer or a layer of opaque white fused silica. The primary reflector can alternatively also be present as a separate sheet metal part 11.2, which rests against the cladding tube 3.1 of the IR lamp 3, 3′.

Furthermore, a reflective inside 12.2 of the housing wall 12.1 of the housing 12 facing the shaped part 5 additionally forms a secondary reflector. The reflective inside 12.2 is formed by a gold or aluminium layer.

In the case of a circular cylindrical construction chamber 1 with a correspondingly circular construction platform 4 and a circular cylindrical side wall 2 around the construction chamber 1, the IR lamp 3, 3′ from FIG. 1 shows two portions of a ring lamp (also known as an omega lamp), which is arranged externally around the cylindrical side wall 2.

If the construction chamber 1 is provided with a construction platform 4 having a rectangular base surface, the IR lamps 3, 3′ are to be understood as individual linear lamps which are mounted on a plurality of levels on the outside of the partition wall 2, the partition wall 2 having the shape of a rectangular cylinder.

To limit heat generation in the region of the housing 12, the housing wall 12.1 is furthermore equipped with a cooling mechanism 12.4 in the form of a cooling plate and/or an insulation mechanism 12.3 in the form of an insulation layer.

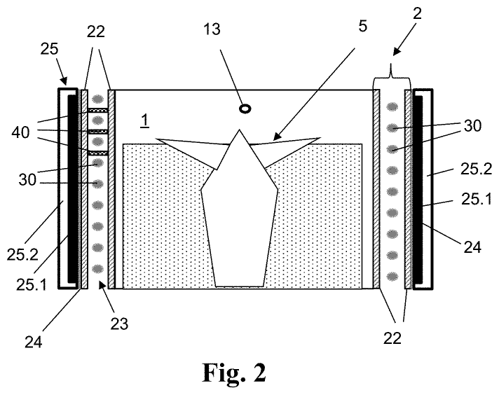

FIG. 2 shows a variant of the heating device, wherein the construction chamber 1 is shown only schematically with the measuring cell 13 in the form of a pyrometer and a partition wall 2 in the form of a double-walled side wall 22 composed of fused silica with an intermediate space 23. In the intermediate space 23 of the double-walled side wall 22, heating filaments 30 composed of Kanthal wires are arranged, which emit IR radiation in the IR-B range. Kanthal is a trademark owned by Sandvik Intellectual Property AB of Sweden for a family of iron-chromium-aluminium alloys used in a wide range of resistance and high-temperature applications. Kanthal FeCrAl alloys consist of mainly iron, chromium (20-30%), and aluminium (4-7.5%). The alloys have intermediate electric resistance and are known for their ability to withstand high temperatures; ordinary Kanthal FeCrAl alloys have a melting point of 1,500° C. Therefore, they are frequently used in heating elements.

The double-walled side wall 22 has the function of a cladding tube for the heating filaments 30. The heating filaments 30 can be configured either as a single, long filament, which is laid in coils from bottom to top in the intermediate space 23 of the double-walled side wall 22, or can be present in the form of individually electrically controllable rings. To separate the rings or coils, webs 40 composed of heat-resistant, electrically insulating material are provided. The webs 40 consist of fused silica, glass ceramic, or ceramic, such as a calcium silicate ceramic available from Calsitherm Silikatbaustoffe GmbH of Germany under the trade name Calcast®. On the outside of the double-walled side wall 22, a reflector layer 24 composed of gold is deposited, which reflects the IR-B radiation from the heating filaments 30 towards the powder P and the shaped part 5 such that an efficient operation of the heating device is obtained. A housing 25 includes a cooling mechanism 25.1 in the form of a cooling plate and an insulation mechanism 25.2 in the form of an insulation layer.

Although illustrated and described above with reference to certain specific embodiments and examples, the present disclosure is nevertheless not intended to be limited to the details shown. Rather, various modifications may be made in the details within the scope and range of equivalents of the claims and without departing from the spirit of the disclosure.

1. A heating device for heating a powder during the production of a 3D shaped part, the heating device comprising,
an infrared (IR) lamp;
a housing in which a construction chamber is provided and which is bounded at the bottom by a construction platform for receiving the shaped part,
a support plate on which the construction platform is supported; and
a partition wall composed of an IR radiation transparent material arranged between the construction chamber and the infrared lamp.

2. The heating device according to claim 1, wherein the material of the IR radiation transparent partition wall consists of fused silica or of a glass ceramic.

3. The heating device according to claim 1, wherein the construction chamber is surrounded in the radial direction by a cylindrical-sleeve-shaped side wall which is formed at least in part, as the partition wall.

4. The heating device according to claim 1, further comprising at least one reflector located on a side of the infrared lamp facing away from the shaped part.

5. The heating device according to claim 4, the IR lamp has a cladding tube which is covered on its side facing away from the shaped part with a primary reflector in the form of a reflector layer deposited on the cladding tube, and the housing has a housing wall with a reflective inside facing the shaped part that forms a secondary reflector.

6. The heating device according to claim 5, wherein the housing wall is equipped with a thermal insulation layer and/or a cooling plate.

7. The heating device according to claim 1, wherein the construction chamber comprises at least one measuring cell for detecting the temperature of the powder and/or of the shaped part.

8. The heating device according to claim 1, wherein the partition wall is of a double-walled configuration forming at least one intermediate space, and the IR lamp is arranged in the intermediate space.

9. The heating device according to claim 8, wherein the double-walled partition wall comprises a double-walled side wall of the construction chamber and the IR lamp comprises individual heating filaments that are mechanically and electrically separated from each other by webs in the double-walled side wall.

10. The heating device according to claim 1, wherein the IR lamp comprises an IR-B lamp with at least one heating filament having an emission spectrum in the IR-B range.

11. The heating device according to claim 1, further comprising a lamp arrangement having a plurality of IR lamps that are individually electrically controllable.

12. The heating device according to claim 1, wherein the IR lamp comprises an IR-A lamp with an emission spectrum in the IR-A range which is matched to the absorption characteristics of the powder.

13. The heating device according to claim 3, further comprising a heating unit having a frame and wherein the IR lamp and the side wall are arranged in the frame of the heating unit, which heating unit is insertable into the housing.

14. The heating device according to claim 13, wherein the frame comprises a frame outer wall with a reflective inside facing the shaped part, which forms a reflector.

15. The heating device according to claim 13, wherein the frame surrounds a closed inner space in which the IR lamp is arranged.

16. A method of producing a 3D shaped part using the heating device according to claim 1.

17. A heating device for heating a powder during the production of a 3D shaped part, the heating device comprising:
an infrared (IR) lamp;
a housing in which a construction chamber is provided and which is bounded at the bottom by a construction platform for receiving the shaped part;
a support plate on which the construction platform is supported;
a partition wall composed of an IR radiation transparent material of fused silica or of a glass ceramic arranged between the construction chamber and the infrared lamp;
at least one measuring cell located in the construction chamber for detecting the temperature of the powder and/or of the shaped part; and
at least one reflector located on a side of the infrared lamp facing away from the shaped part.

18. The heating device according to claim 17, wherein the IR lamp has a cladding tube with a side facing away from the shaped part covered by a primary reflector in the form of a reflector layer deposited on the cladding tube, and the housing has a housing wall with a reflective inside facing the shaped part that forms a secondary reflector.

19. The heating device according to claim 17, wherein the partition wall is of a double-walled configuration forming at least one intermediate space, and the IR lamp is arranged in the intermediate space.

20. The heating device according to claim 19, wherein the double-walled partition wall comprises a double-walled side wall of the construction chamber and the IR lamp comprises individual heating filaments that are mechanically and electrically separated from each other by webs in the double-walled side wall.
